(19) United States
(12) Patent Application Publication
(10) Pub. No.: US 2019/0124962 A1
(43) Pub. Date: May 2, 2019

(54) RAW, FROZEN GROUND BEEF (AND/OR OTHER MEAT), METHOD FOR MAKING SAME, AND PACKAGING FOR DISPLAYING SAME

(71) Applicant: The Paget Group, Inc., Madison, WI (US)

(72) Inventors: Heidi A. Meyer, Madison, WI (US); Jeffrey C. Meyer, Madison, WI (US)

(21) Appl. No.: 16/169,366

(22) Filed: Oct. 24, 2018

Related U.S. Application Data
(60) Provisional application No. 62/577,574, filed on Oct. 26, 2017.
(60) Provisional application No. 62/671,133, filed on May 14, 2018.

(51) Int. Cl. A23L 13/60; A23L 13/50; A23B 4/06

(52) U.S. Cl. CPC A23L 13/60; A23L 17/70; A23B 4/064; A23L 13/52

(57) ABSTRACT

A raw frozen meat product is disclosed. The meat product is provided in a package in a range of sizes less than one-half inch in irregular diameter, each size making up a predetermined percentage by weight of the total meat in the package. The meat is provided in a tray and a carton for receiving the tray of meat. The carton includes a bottom surface, a top surface, a rear surface and a front surface, is self-standing on the bottom and rear surface, and the top surface and the front surface define a cutout so that the meat product can be visually examined by a consumer when standing on the bottom surface or rear surface.

### CROSS REFERENCE TO RELATED APPLICATIONS

The application claims benefit of U.S. Provisional Patent Application Ser. No. 62/577,574, filed Oct. 26, 2017; and 62/671,113, filed May 14, 2018; each of which is herein incorporated by reference in its entirety.

### BACKGROUND

The processing of ground meat is well known. Ground meat is typically processed by blending different ratios of lean meat and fat together into a meat blend. The meat blend is then ground, comminuted, or reduced in size, and extruded using meat extrusion devices. However, known methods of ground meat production produce a finished product that is not as desirable as it could be to consumers.

For example, ground meat in grocery stores is typically sold refrigerated. However, the majority of refrigerated ground meat is later frozen by consumers for inventory. Additionally, when purchasing larger quantities (such as at club stores or when on sale), consumers often portion or repack ground meat before freezing into one-pound portions into bags or plastic wrap. Portioning and repacking the meat is laborious, messy and exposes the meat to pathogens and the like. Whether repacked at home or left in known trays, the resultant frozen “brick” of ground meat is time-consuming and difficult to thaw and cook. Time may be spent thawing the product on a counter or in a microwave, or the consumer may attempt to thaw and cook the entire brick in a pan, resulting in unevenly cooked edges, raw centers and continuous efforts to chip, portion or otherwise piece the meat into manageable sizes. The thaw step is especially challenging and time consuming, given that most ground meat masses are one to two inches thick.

In addition, when a consumer purchases ground meat and goes to cook that meat, they typically have to take that meat out of the package and handle it in order to prepare it. If the meat is intended to be cooked in a skillet, e.g., for tacos, sloppy joes, or any other meal where the meat is cooked to a pieced state, the user must typically handle and break up the meat from its original compacted state. The unfortunate result is that consumers have to deal with physically handling meat, portioning it to desired amounts, and potentially making a mess.

In an effort to provide a meat product without such drawbacks and challenges, some manufacturers, such as Jimmy Dean Foods, are known to have offered precooked (not raw), frozen, pieced sausage, soy or beef products. However, these products had limited consumer use because they were precooked. In addition, the product was sold in opaque pouches that did not allow for visual inspection by consumers. Such pouches were confusing for consumers as such packaging conceals whether the product inside is cooked or raw.

In other efforts to provide an alternative meat product a flash frozen meat product was distributed for some time under the Chatel farms brand. However, the Chatel Farms brand product had a long, uniform noodle or strand shape that was inferior-looking for consumer acceptability. In product optimization research, consumers found the Chatel Farms brand strand unappealing to look at and eat, as it was too uniform and manufactured-looking. The manufacturing process also gave the meat product a pinkish gray color, rather than the red or pink coloration consumers identify with a product that is uncooked and fresh. Additionally, the product was marketed as not needing browning, an important step for consumer acceptability and pathogen kill. The product was also sold in an opaque pouch with no ability to view or inspect the meat for understanding, acceptability or spoilage.

A product similar to the Chatel Farms brand product has been found in Europe. But, the product has the look of “erasers” or tubes of meat that are unappealing to view, cook and eat. In addition, the product is also again packaged in a pouch.

Some of the disadvantages and drawbacks of known meat products were noted in U.S. Patent Application Pub. No. US 2007/0071878, in the name of Swift & Company, entitled “The Process for Making Frozen Ground Meat Pieces and Product Made Thereby” (“Swift”). Swift also disclosed other possible or potential processes for a more appealing frozen ground meat product. However, most if not all of the processes disclosed therein do not work or are otherwise unsatisfactory for making the meat product described therein. For example, Swift disclosed freezing the meat after extrusion, and while the meat is blended inside of a known type of blender during processing. However, in actuality, it is extremely difficult to control the process of freezing in the blender as smaller pieces tend to freeze before larger pieces and the process eventually results in a frozen paste of meat. In addition, Swift disclosed passing the meat through a typical grinder at a temperature of about 25 deg F to about 40 deg F. As it turns out, however, typical grinders are not designed to work well at these low temperatures, and they often freeze up or break. At the same time, typical grinding at these temperatures, which can be below freezing, results in undesirable “eraser” or tubular shapes that are longer than they are wide and tend to look “manufactured” or processed,

In addition, Swift discloses the use of an improved extruder design having holes of various sizes and configurations and paddies spaced apart at different angular intervals to cause the meat to be pushed out to different sizes as it is cut off. However, in practice, this process does not work as the pressure during extrusion causes the meat to spray and splatter rather than keep its shape.

Swift also discloses creating regularly shaped meat product by freezing a large portion of meat and then shattering it. However, in practice, the shattered product remains in undesirable flat shape and appearance, even after cooking.

As evidenced by Swift, there is a need for a finished frozen ground meat product but a number of lacking products and methods for making such product.

The packaging of ground meat is also well known. The most common form of packaging for uncooked meat in the U.S. (such as ground beef, ground turkey, etc.) is typically a rigid plastic or foam tray, which holds the food or meat product, and is wrapped and/or sealed with a plastic film. The plastic film is typically transparent to allow prospective consumers to see the food in the packaging. When the food and packaging is displayed in a typical refrigerated merchandiser (e.g., a meat and deli merchandiser or bunker), the packaging is displayed tray down with the plastic film facing up so prospective consumers can see through the plastic film and view the product in the packaging.

However, such packaging does not work well for displaying the food and packaging in a frozen merchandiser such as an upright or vertical display, a freezer display case with or without doors, or a freezer merchandising case. For example, freezers typically have horizontal shelving and, because typical meat trays are not designed to stand on an edge or side, typical meat packaging is provided on the shelving in a stacked configuration with the plastic film side up similar to how it is provided in a typical bunker merchandiser. Such stacking can make it difficult for consumers to see labels or information on the plastic film, or the food inside the packaging, without physically removing the packaging from the frozen merchandiser.

To make it easier for consumers to view the food product in such merchandisers, some retailers will use spring-loaded pusher trays. Such pusher trays help keep food packaging standing on its edge or side to position the packaging to make it easier for consumers to view the packaged product without removing it from the freezer case. However, such pusher trays are typically an unwanted expense and hassle (e.g., a stocking and maintenance hassle) for retailers.

### SUMMARY

A need exists for a finished frozen, raw/uncooked meat product, a method for processing or manufacturing this meat product, and packaging for this product, that offers the following advantages, and/or combination of advantages:
Easier, faster, and/or better processing method that helps create piece separation to improve cooking ability from a frozen state;
Easier, faster, and better method for processing in that the frozen meat product is produced in such a way that provides a more desirable, unique, irregular shape to increase consumer acceptability;
Unique and novel grinder plate shapes that help create more random, more natural product appearance and also help control distribution or range of meat these sizes;
Improved ease of storage—product is packaged in a freezer-ready package, not in make-shift or lumpy pouches or bags, similar in general appearance to typical tray execution already known to the consumer;
Improved ease of use—simply pour frozen pieces, fragments or pieced meat into a pan to cook, no prep or planning required;
Elimination of a separate thaw step prior to consumer use, which means less or no need to handle or manipulate meat and which reduces the introduction of contaminants and/or the risk of having raw meat contaminate other food or food preparation surfaces;
Smaller piece size allows for meat to cook relatively quickly and evenly without requiring a separate thaw step;
Irregular shape and size that leads to a cooked product that is consistent with how raw meat typically looks after cooking;
Tray that consumers may reuse as a receptacle for the drained ground beef fat/liquid;
A carton for receiving a meat tray that will help the meat tray stand up vertically on its side on a shelf, without the need for pusher trays;
A carton for receiving a meat tray which readily displays or communicates information about the product and/or product contents, whether the tray is displayed side down or tray down with the plastic film facing up;
A carton for receiving a meat tray which allows for viewing of the packaged product even while in the carton;
A carton for receiving a meat tray including a paperboard format which provides room for improved quality printing (compared to, e.g., using only printed film on a tray) for communicating required and desirable information to consumer;
A carton for receiving a meat tray which helps a package display nicely regardless of where/how retailers choose to shelve the product; and
Use of modified-atmosphere gases beyond just inert nitrogen gases to maintain color consistent with typical uncooked meat and improve attractiveness and appeal to consumers at time of purchase.

It is thus one aspect of the present disclosure to provide a frozen ground meat produce in a fragmented, pieced, and/or crumbled form. The ground meat pieces are provided in a form that consumers prefer when they are purchasing and/or preparing the meat. The methods of processing or manufacturing give the product a more desirable shape and help keep the product free-flowing. The product more readily cooks directly from a frozen state because of its smaller and irregular size and increased surface area relative to known frozen meat products. It is another aspect of the present disclosure to provide a unique combination of form and package of frozen raw meat for further preparation. The disclosed product form and package provides, among other things, the benefit of reducing or eliminating any requirement to separately thaw the product before consumer cooking or use. The product is packaged in a sealed, modified-atmosphere tray such that it maintains an appearance and color consistent with typical uncooked meat. The product is further packaged in a carton with a window that displays and merchandises the product in-store to consumers, whether laying down or standing up on a side. In addition, the tray may be used to help contain fat and other cooked meat liquid commonly produced during cooking of meat products.

It is thus one aspect of the present disclosure to provide a meat product comprising: a package of ground irregularly-shaped pieces of frozen, raw meat; whereby a first percentage of pieces in the package have a maximum irregular diameter less than 3/16″; whereby a second percentage of pieces in the package have a maximum irregular diameter ranging from 3/16″ to less than 5/16″; whereby a third percentage of pieces in the package have a maximum irregular diameter ranging from 5/16″ to less than ⅜″; whereby a fourth percentage of pieces in the package have a maximum irregular diameter ranging from ⅜″ to less than ½″; and whereby the first, second, third and fourth percentages are each greater than one percent.

### BRIEF DESCRIPTION OF THE DRAWINGS

Various examples of embodiments of the systems, devices, and methods according to this invention will be described in detail, with reference to the following figures, wherein:

FIG. 1 illustrates a perspective view of a tray of raw, frozen ground meat, according to various examples of embodiments;

FIG. 2 illustrates a top view of FIG. 1;

FIG. 3 illustrates a perspective view of a packaged raw, frozen ground meat product, according to various examples of embodiments; and

FIG. 4 illustrates a plan view of the packaged product illustrated in FIG. 3.

It should be understood that the drawings are not necessarily to scale. In certain instances, details that are not necessary to the understanding of the invention or render other details difficult to perceive may have been omitted. It should be understood, of course, that the invention is not necessarily limited to the particular embodiments illustrated herein.

### DETAILED DESCRIPTION

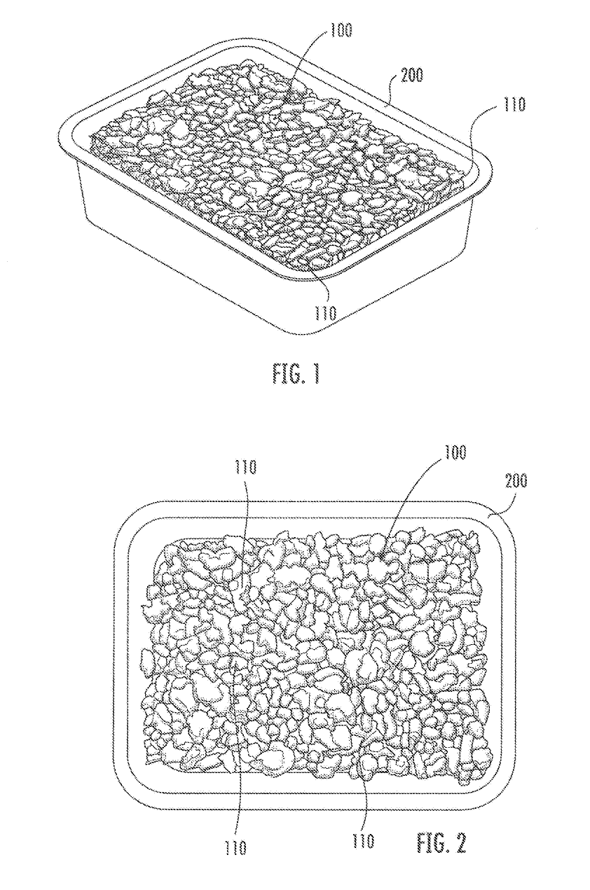

Referring to FIGS. 1-2, examples of a raw frozen ground meat product 100 in packaging or a packaging component (e.g., a tray 200) are illustrated. In various embodiments, the raw materials for the disclosed meat product and process include ground beef, pork, poultry, turkey, veal, lamb, and/or chicken meat and/or a blend or combination of meats. Each meat species may have specific USDA standards of identity. For example, these raw materials may have specific USDA standards of identity such as Ground Beef, Ground Beef Chuck, and Ground Beef Round, where the product can only contain material from skeletal muscle and fatty tissue that is ground to specific sizes and does not contain any other non-meat ingredients and, in the case of beef, has a maximum percent fat content of thirty percent. While “meat,” as defined herein, is understood to include any one of beef, poultry, pork, lamb, fish, or the like, “meat” can also generally include non-meat items such as vegetables, starch components, tofu, and/or soy-based products, in combination with animal-derived portions.

In various embodiments, meat product 100 is typical of ground beef (or other ground meat) in that it has a lean content of seventy-three percent to ninety-three percent but is more preferably eighty percent to ninety percent lean. In the case of ground beef, in various embodiments, product 100 is one hundred percent pure beef containing no additives, no preservatives and no artificial colors, and is made of typical or grass-fed beef and is all natural.

In various embodiments, product 100 is provided in fragmented, pieced, and/or crumbled form 110. In various embodiments, the sizes of pieces 110 are relatively small and varied. In various embodiments, pieces 110 have an irregular diameter ranging from between 3/16″ and 5/16″ which helps pieces 110 to concurrently and/or contemporaneously thaw and cook relatively evenly. While some clumping and size and shape variation and other irregularity may occur, in various embodiments, the irregular diameter of most pieces 110 (e.g., in a tray 200) does not exceed ½″.

The term diameter is used to describe the relative size of an individual meat piece or fragment 110 and, in various embodiments, meat pieces or fragments 110 typically have an irregular diameter (and are not perfectly round). Typically meat pieces of irregular size and shape are desired. Therefore, the use of the term “irregular diameter” is used herein to define the relative size of the meat pieces. Also, “irregular diameter” describes a meat piece that does not necessarily have a circular disposition. Preferably, the meat pieces have characteristics similar to those of crumbled, browned meat a consumer would prepare in a browning skillet or similar cooking apparatus. However, certain circumstances may exist where a more uniformly shaped meat piece is desired rather than the traditional non-uniform pieces, and “irregular diameter” can also describe a substantially spherical or round meat piece.

In various examples of embodiments, pieces 110 are generally irregularly shaped, and not uniform or spherical in appearance. In various embodiments, pieces 110 generally have a pink or red coloration when frozen and packaged.

In various embodiments, most pieces or fragments 110 by weight (e.g., in a package or tray 200) are irregularly shaped and range from about 3/16″ to ½″ in irregular diameter. In various embodiments, most pieces or fragments 110 by weight (e.g., in a package or tray 200) are irregularly shaped and range from about 3/16″ to ⅜″ in irregular diameter. In various embodiments, most pieces or fragments 110 by weight (e.g., in a package or tray 200) are irregularly shaped and range from about 3/16″ to 5/16″ in irregular diameter. In various embodiments, most pieces or fragments 110 by weight (e.g., in a package or tray 200) are irregularly shaped and range from about 5/16″ to ⅜″ in irregular diameter. In various embodiments, most pieces or fragments 110 by weight (e.g., in a package or tray 200) are irregularly shaped and range from about 5/16″ to ½″ in irregular diameter.

In various embodiments, pieces or fragments 110 (e.g., in a package or tray 200) have a maximum irregular diameter dimension of ½″. In various embodiments, most pieces or fragments 110 by weight (e.g., in a package or tray 200) have a maximum irregular diameter dimension of ½″. In various embodiments, pieces or fragments 110 (e.g., in a package or tray 200) have a maximum irregular diameter dimension of ⅜″. In various embodiments, most pieces or fragments 110 by weight (e.g., in a package or tray 200) have a maximum irregular diameter dimension of ⅜″. In various embodiments, pieces or fragments 110 (e.g., in a package or tray 200) have a minimum irregular diameter dimension of about 11/64″. In various embodiments, most pieces or fragments 110 by weight (e.g., in a package or tray 200) have a minimum irregular diameter dimension of 11/64″.

In various embodiments, the majority of pieces 110 by weight (e.g., in a package or tray 200) are individual pieces, rather than provided in clusters. However, meat product 100 may include clustered pieces or clusters. In various embodiments, less than twenty-five percent of meat product 100 by weight (e.g., in a package or tray 200) is clustered or in clusters. In various embodiments, meat product 100 (e.g., in a package or tray 200) includes no clusters greater than 1″ in irregular diameter. In various embodiments, less than twenty-five percent of meat product 100 by weight in a package or tray 200) is in clusters greater than 1″ in irregular diameter.

In various examples of embodiments, meat product 100 includes pieces or fragments having a variety of irregular diameters. For example, in various embodiments, product 100 by weight (e.g., in packaging or tray 200) includes one percent to fifteen percent pieces or fragments 110 having a maximum irregular diameter less than 3/16″. In various embodiments, product 100 by weight (e.g., in packaging or tray 200) includes twenty=percent to thirty five percent pieces or fragments 110 having a maximum irregular diameter from 3/16″ to less than 5/16″. In various embodiments, product 100 by weight (e.g., in packaging or tray 200) includes twenty-five percent to forty percent pieces or fragments 110 having a maximum irregular diameter from 5/16″ to less than ⅜″. In various embodiments, product 100 by weight (e.g., in packaging or tray 200) includes ten percent to twenty-five percent pieces or fragments 110 having a maximum irregular diameter from ⅜″ to less than ½″. In various embodiments, product 100 by weight (e.g., in packaging or tray 200) includes ten percent to twenty percent pieces or fragments 110 having a maximum irregular diameter of about ½″.

As another example, in various embodiments, product 100 by weight (e.g., in packaging or tray 200) includes one percent to seven percent pieces or fragments 110 having a maximum irregular diameter less than 3/16″. In various embodiments, product 100 by weight (e.g., in packaging or tray 200) includes twenty-four percent to thirty percent pieces or fragments 110 laving a maximum irregular diameter from 3/16″ to less than 5/16″. In various embodiments, product 100 by weight (e.g., in packaging or tray 200) includes twenty-eight percent to thirty-four percent pieces or fragments 110 having a maximum irregular diameter from 5/16″ to less than ⅜″. In various embodiments, product 100 by weight (e.g., in packaging or tray 200) includes thirteen percent to nineteen percent pieces or fragments 110 having a maximum irregular diameter from ⅜″ to less than ½″. In various embodiments, the product by weight (e.g., in packaging or tray 200) includes twelve percent to eighteen percent pieces or fragments 110 having a maximum irregular diameter of about ½″.

As another example, in various embodiments, product 100 by weight (e.g., in packaging or tray 200) includes about four percent pieces or fragments 110 having a maximum irregular diameter less than 3/16″. In various embodiments, product 100 by weight (e.g., in packaging or tray 200) includes about twenty-seven percent pieces or fragments 110 having a maximum irregular diameter from 3/16″ to less than 5/16″. In various embodiments, product 100 by weight (e.g., in packaging or tray 200) includes about thirty-one percent pieces or fragments 110 having a maximum irregular diameter from 5/16′ to less than ⅜″. In various embodiments, product 100 by weight (e.g., in packaging or tray 200) includes about sixteen percent pieces or fragments 110 having a maximum irregular diameter from ⅜″ to less than ½″. In various embodiments, product 100 by weight (e.g., in packaging or tray 200) includes about fifteen percent pieces or fragments 110 having a maximum irregular diameter of about ½″.

In various embodiments, raw materials proximate analysis compositions in this disclosure include chemical lean contents (moisture and fat in the raw material) in the range of seventy percent to ninety-eight percent with it more preferably being eighty percent to ninety percent.

Raw materials formulations containing non-meat ingredients and additives such as salt, spices, and USDA-approved extenders and ingredients may also be used to create specific flavored raw meat pieces such as taco meat pieces, chili meat pieces, Italian meat pieces used for spaghetti, etc.

The product may be seasoned with spices or sauces. Example seasonings include salt and pepper, Italian spice blend (for spaghetti or lasagna, for example), Mexican/taco or chili spice blend, sloppy joe spice blend, spaghetti sauces, sloppy joe sauce, etc. The product may be sold “With . . .” added other food, such as, for example, diced onion, peppers and/or celery.

In various examples of embodiments, the meat pieces are packaged for sale in tray 200. In various embodiments, tray 200 looks similar to that typically used in the sale of refrigerated, raw ground beef. Instead of expanded polystyrene, however, various examples of embodiments of tray 200 are made of a plastic amenable to being stored in an environment below freezing, and which contains an oxygen barrier such as Polypropylene or multi-layered structures. In various embodiments, tray 200 is made of a rigid plastic. It should be appreciated, however, that tray may be made of other types of materials (such as various foams). In various embodiments, the film is a clear plastic film. The disclosed tray allows the consumer or user to drain fat into the tray, thereby reusing it and providing a secondary function. The tray is approximately 8¾×6½2″ deep but can be other dimensions, including those that yield approximately the same volume.

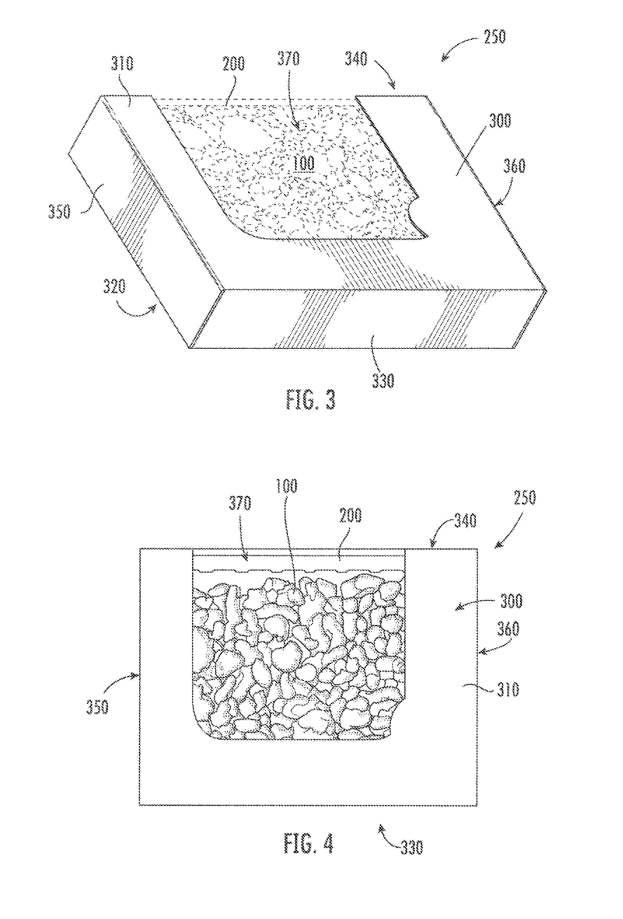

Referring to FIGS. 3-4, in various examples of embodiments, tray 200 including meat product 100 is merchandised in a packaging system 250 including a display carton 300 adapted to receive tray 200. In various examples of embodiments, display carton 300 includes a front surface 310, an opposing rear surface 320, a bottom surface 330, a top surface 340, and opposing side surfaces 350/360.

In various embodiments, front surface 310 defines a cutout or window 370. In various embodiments, top surface 340 also helps define cutout or window 370. In various embodiments, one or both of the side surfaces also help define the cutout or window.

In various embodiments, cutout or window 370 extends a distance between opposing side surfaces 350/360. In various embodiments, cutout or window 370 extends approximately zero to one hundred percent of the distance between opposing side surfaces 350/360. In various embodiments, cutout or window 370 extends approximately five to one hundred percent of the distance between opposing side surfaces 350/360. For example, in various embodiments, cutout or window 370 extends up to approximately sixty to seventy percent of the distance between opposing side surfaces 350/360.

In various embodiments, cutout or window 370 extends a distance between the top surface 340 and bottom surface 330. In various embodiments, cutout or window 370 extends approximately five to one hundred percent of the distance between top surface 340 and bottom surface 330. For example, in various embodiments., cutout or window 370 extends up to approximately seventy to eighty percent of the distance between the top and bottom surfaces 340/330.

In various embodiments, cutout or window 370 extends a distance between the front surface 310 and rear surface 320. In various embodiments, cutout or window 370 extends approximately five percent to one hundred percent of the distance between the front and rear surfaces 310/320. For example, in various embodiments, cutout or window 370 extends up to approximately fifty to one hundred percent of the distance between the top and bottom surfaces 310/320.

In various embodiments, window or cutout 370 allows for visual inspection of product and/or quality (e.g., by the consumer). It should be appreciated, however, that the display carton does not need to define a cutout or window. It should also be appreciated that the window may he defined by other portions of the display carton including the bottom surface, the top surface and/or the opposing side surfaces.

In various embodiments, display carton 300 is made of paper board. In various embodiments, the display carton is made of corrugated board (e.g., a light corrugated board). It should be appreciated that relatively thicker material may help maintain the meat tray and/or packaging system standing on its bottom surface.

In various embodiments, packaging system 250 including tray 200 and carton 300 is self-supporting or self-standing on its bottom surface 330, or its rear surface 320. Display carton 300 may be displayed or otherwise stored (e.g., stacked) on its bottom surface 330 (i.e., in a vertical orientation) and displayed or otherwise stored on its rear surface 320 (i.e., in a horizontal orientation). In various embodiments, carton 300 can be displayed or otherwise stored on rear surface 320, bottom surface 330, or either opposing side surfaces 350/360. In various embodiments, and because of the different display possibilities, front surface 310, rear surface 320, bottom surface 330, top surface 340, and/or at least one opposing side surface 350/360 of carton 300 includes product information for consumers or prospective consumers.

Carton 300 may allow for a visual billboard in-store and may also stack neatly in a freezer display case and/or a consumer's freezer. Packaging system 250 including display carton 300 and meat tray 200 may be displayed resting on bottom surface 330 of display carton 300, to allow the prospective consumer to view the information available on front surface 310 of partial carton 300 and/or the product itself sealed within the film sealing tray 200 (e.g., while packaging system 250 is displayed in a case (e.g., a freezer case). Packaging system 250 may be displayed on its own or in a horizontally stacked configuration with other packaging systems, without the need for a pusher tray or other support. Packaging system 250 may also be displayed such that at least one of opposing sides 350/360, and/or information thereon are viewable by a prospective consumer when packaging system 250 is displayed in a case (e.g., a freezer case).

A carton may also allow for multiple bags or trays (e.g., multiple one-pound bags for club store sales, multiple unit sales, two eight-ounce packages in one carton, etc.). Other amounts or weights or packaging may also be utilized. For example, multi-pound packaging (e.g., two, three, or five pound) may be utilized for better value and/or club stores, or one half pound internal packaging for recipe flexibility. This could include a gusseted or standup pouch or pouch or pouches in a carton or a master case, such as for foodservice use.

It should be understood that the drawings are not necessarily to scale. In certain instances, details that are not necessary to the understanding of the invention or render other details difficult to perceive may have been omitted. It should be understood, of course, that the invention is not necessarily limited to the particular embodiments illustrated herein.

As utilized herein, the terms “approximately,” “about,” “substantially,” and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should he interpreted as indicating that insubstantial or inconsequential modifications or alterations of the subject matter described and claimed are considered to be within the scope of the invention as recited in the appended claims.

It should be noted that references to relative positions (e.g., “top” and “bottom”) in this description are merely used to identify various elements as are oriented in the Figures. It should be recognized that the orientation of particular components ma vary greatly depending on the application in which they are used.

It is also important to note that the construction and arrangement of the system, methods, and devices as shown in the various examples of embodiments is illustrative only. Although only a few embodiments have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements show as multiple parts may be integrally formed, the operation of the interfaces may be reversed or otherwise varied, the length or width of the structures and/or members or connector or other elements of the system may be varied, the nature or number of adjustment positions provided between the elements may be varied (e.g. by variations in the number of engagement slots or size of the engagement slots or type of engagement). The order or sequence of any process or method steps may be varied or re-sequenced according to alternative embodiments. Other substitutions, modifications, changes and omissions may be made in the design, operating conditions and arrangement of the various examples of embodiments without departing from the spirit or scope of the present inventions.

While this invention has been described in conjunction with the examples of embodiments outlined above, various alternatives, modifications, variations, improvements and/or substantial equivalents, whether known or that are or may be presently foreseen, may become apparent to those having at least ordinary skill in the art. Accordingly, the examples of embodiments of the invention, as set forth above, are intended to be illustrative, not limiting. Various changes may be made without departing from the spirit or scope of the invention. Therefore, the invention is intended to embrace all known or earlier developed alternatives, modifications, variations, improvements and/or substantial equivalents.

We claim:

1. A meat product comprising:
a package of ground irregularly-shaped pieces of frozen, raw meat;
whereby a first percentage of pieces in the package have a maximum irregular diameter less than 3/16″;
whereby a second percentage of pieces in the package have a maximum irregular diameter ranging from 3/16″ to less than 5/16″;
whereby a third percentage of pieces in the package have a maximum irregular diameter ranging from 5/16″ to less than ⅜″;
whereby a fourth percentage of pieces in the package have a maximum irregular diameter ranging from ⅜″ to less than ½″; and
whereby the first, second, third and fourth percentages are each greater than one percent.

2. The meat product of claim 1, whereby the first percentage ranges from one to fifteen percent.

3. The meat product of claim 2, whereby the first percentage ranges from one to seven percent.

4. The meat product of claim 3, whereby the first percentage is about four percent.

5. The meat product of claim 1, whereby the second percentage ranges from twenty to thirty-five percent.

6. The meat product of claim 5, whereby the second percentage ranges from twenty-four to thirty percent.

7. The meat product of claim 6, whereby the second percentage is about twenty-seven percent.

8. The meat product of claim 1, whereby the third percentage ranges from twenty-five to forty percent.

9. The meat product of claim 8, whereby the third percentage ranges from twenty-eight to thirty-four percent.

10. The meat product of claim 9, whereby the third percentage is about thirty-one percent.

11. The meat product of claim 1, whereby the fourth percentage ranges from ten to twenty-five percent.

12. The meat product of claim 11, whereby the fourth percentage ranges from thirteen to nineteen percent.

13. The meat product of claim 12, whereby the fourth percentage is about sixteen percent.

14. The meat product of claim 1, whereby the third percentage is larger than the each of the first, second and fourth percentages.

15. The meat product of claim 14, whereby the third percentage is larger than the first percentage and the fourth percentage combined.

16. The meat product of claim 1, whereby the second percentage is larger than each of the first percentage and the fourth percentage.

17. The meat product of claim 16, whereby the second percentage is larger than the first percentage and the fourth percentage combined.

18. The meat product of claim 1, whereby the second and third percentages are larger than the first and fourth percentages.

19. The meat product of claim 1, whereby the package includes a display carton which receives a tray and the meat product;
whereby the display carton comprises a top surface, a bottom surface, a front surface, a rear surface, and opposing side surfaces; and whereby
the front surface helps define a cutout such that the meat product can be visually examined while in the display carton.

20. The meat product of claim 19, whereby the display carton is self-supporting whether resting on its bottom surface or its rear surface.
